(19) United States
(12) Patent Application Publication
(10) Pub. No.: US 2023/0198117 A1
(43) Pub. Date: Jun. 22, 2023

(54) SELF SUPPORTING STRIPLINE STRUCTURE

(71) Applicant: Raytheon Company, Waltham, MA (US)

(72) Inventor: Channing Paige Favreau, Barre, MA (US)

(73) Assignee: Raytheon Company, Waltham, MA (US)

(21) Appl. No.: 18/053,521

(22) Filed: Nov. 8, 2022

Related U.S. Application Data
(60) Provisional application No. 63/290,811, filed on Dec. 17, 2021.

(51) Int. Cl. H01P 3/08; H01P 11/00; H01P 1/30

(52) U.S. Cl. CPC H01P 3/08; H01P 11/003; H01P 1/30

(57) ABSTRACT

Methods and apparatus for a self-supported stripline structure including a center conductor having stubs. Opposing first and second ground planes form a cavity in which the center conductor is located. Opposing first and second lateral structures enclose the cavity sides. A first one of the stubs is connected to the first lateral structure to fix the center conductor in position within the cavity.

### CROSS REFERENCE TO RELATED APPLICATION

The present application claims the benefit of U.S. Provisional Patent Application No. 63/290,811, filed on Dec. 17, 2021, entitled “SELF SUPPORTING STRIPLINE STRUCTURE,” the entirety of which is hereby incorporated by reference.

### BACKGROUND

As is known in the art, there are a wide variety of connection technologies to interconnect one electronic component to another. Example connection types include coaxial cables, stripline, microstrip, waveguides, and the like. Each connection type has advantages and disadvantages based on various parameters, such as frequency of operation, connection length, cost, size, power handling, etc.

As the demand for higher frequency increases, interconnects may become a limiting factor. For example, as Active Electronically Scanned Arrays (AESAs) frequency of operation increases and overall package size decreases, interconnects may become a significant consideration for overall size of packages. Attempts have been made to shrink cable sizes as much as possible, which become more lossy and reduce power handling. Shrinking connector sizes may add loss but may also remain relatively large. Integrated waveguides may provide some advantages but are relatively bulky.

### SUMMARY

Example embodiments of the disclosure provide methods and apparatus for a stripline configuration that is self-supported by a series of stubs connected to lateral substrates that also achieve desired frequency performance characteristics. With this arrangement, a stripline structure can perform well in multiple frequency bands and be significantly smaller than waveguides. In some embodiments, self-supporting stripline embodiments can be integrated into existing structures eliminating the need for cables. In addition, the stripline stubs may improve thermal dissipation characteristics for an assembly.

In one aspect, a system comprises: a stripline structure comprising: a center conductor having stubs; opposing first and second ground planes that form a cavity, wherein the center conductor is located in the cavity; and opposing first and second lateral structures, wherein the first lateral structure extends from the first and second ground planes to enclose a first side of the cavity and the second lateral structure extends from the first and second ground planes to enclose a second side of the cavity, wherein a first one of the stubs is connected to the first lateral structure to fix the center conductor in position within the cavity.

A system can further include one or more of the following features: the first one of the stubs is electrically connected to the first lateral structure, a second one of the stubs is connected to the second lateral structure to fix the center conductor in position within the cavity, the second one of the stubs is electrically connected to the second lateral structure, the first and second ground planes and the first and second lateral structures comprise the same material, the material is aluminum, the stripline structure is cast, the stripline structure is printed, a dielectric material in the cavity is air, a number of the stubs, location of the stubs, and geometry of the stubs determine a frequency response of the stripline structure, the connection of the first one of the stubs and the first lateral structure provides a thermal dissipation path, the system further includes first and second electrical devices connected by the stripline structure, and/or the system includes antenna elements.

In another aspect, a method comprises: connecting a first electrical device to a second electrical device using a stripline structure, wherein the stripline structure comprises: a center conductor having stubs; opposing first and second ground planes that form a cavity, wherein the center conductor is located in the cavity; opposing first and second lateral structures, wherein the first lateral structure extends from the first and second ground planes to enclose a first side of the cavity and the second lateral structure extends from the first and second ground planes to enclose a second side of the cavity, wherein a first one of the stubs is connected to the first lateral structure to fix the center conductor in position within the cavity.

A method can further include one or more of the following features: replacing a coaxial cable or a waveguide with the stripline structure, the first and second electrical devices comprise circuit boards.

In a further aspect, a method comprises: providing a stripline structure comprising: a center conductor having stubs; opposing first and second ground planes that form a cavity, wherein the center conductor is located in the cavity; and opposing first and second lateral structures, wherein the first lateral structure extends from the first and second ground planes to enclose a first side of the cavity and the second lateral structure extends from the first and second ground planes to enclose a second side of the cavity, wherein a first one of the stubs is connected to the first lateral structure to fix the center conductor in position within the cavity, by selecting a number of the stubs for a given frequency response of the stripline structure.

A method can further include selecting a location of the stubs for the given frequency response of the stripline structure, selecting a length of the stubs for the given frequency response of the stripline structure, and/or selecting a width of the stubs for the given frequency response of the stripline structure.

### BRIEF DESCRIPTION OF THE DRAWINGS

The foregoing features of this disclosure, as well as the disclosure itself, may be more fully understood from the following description of the drawings in which:

FIG. 1A is an isometric view of a self-supporting stripline embodiment, FIG. 1B is a cross-sectional view of the stripline embodiment of FIG. 1A, and FIG. 1C shows the stripline embodiment of FIG. 1A with example dimensions;

FIG. 2A is a graphical representation of a frequency response of an example stripline embodiment and a comparable conventional waveguide;

FIG. 2B is a graphical representation of a mode S(1,1) and mode S(2,1) frequency response for example stripline embodiment;

FIG. 3A is an isometric view with an example stripline embodiment with example dimensions and FIG. 3B is a cross-sectional isometric view of the stripline embodiment of FIG. 3A;

FIG. 4 is an isometric view of an example stripline embodiment having a series of blocks;

FIG. 5 is a pictorial representation of an example stripline embodiment that was 3D printed;

FIG. 6 is a schematic representation showing a self-supporting stripline structure connection first and second circuit boards;

FIG. 7 is a schematic representation of a prior coaxial connection between first and second circuit boards;

FIG. 8 is a flow diagram showing an example sequence of steps for determining an example stripline configuration to achieve an example frequency response from a set of input parameters; and

FIG. 9 is a schematic representation of an example computer that can perform at least a portion of the processing described herein.

### DETAILED DESCRIPTION

Before describing example embodiments of the disclosure, some information is provided. A stripline circuit includes a conductive strip between ground planes which are typically parallel. The conductive strip may be surrounded and supported by an insulative material that forms a dielectric. The characteristics of the conductive strip, such as thickness, and substrate permittivity determine the characteristic impedance of the conductive strip which forms a transmission line. The ground planes are shorted together, such as by conductive vias, to prevent the propagation of unwanted modes. Stripline circuits are non-dispersive and provide good trace isolation characteristics with enhanced noise immunity. The effective permittivity of stripline conductors equal the relative permittivity of the dielectric substrate due to wave propagation only in the substrate.

Tuning stubs may be used in stripline circuits to achieve certain performance characteristics. A stub refers to a length of transmission line or waveguide that is connected at one end only and may be left open-circuit or short-circuited, i.e., connected to ground. Neglecting transmission line losses, the input impedance of a tuning stub is substantially reactive. That is, the stub is capacitive or inductive depending on the electrical length of the stub and its connection (open or short circuited). Stubs may be considered as frequency-dependent capacitors and frequency-dependent inductors.

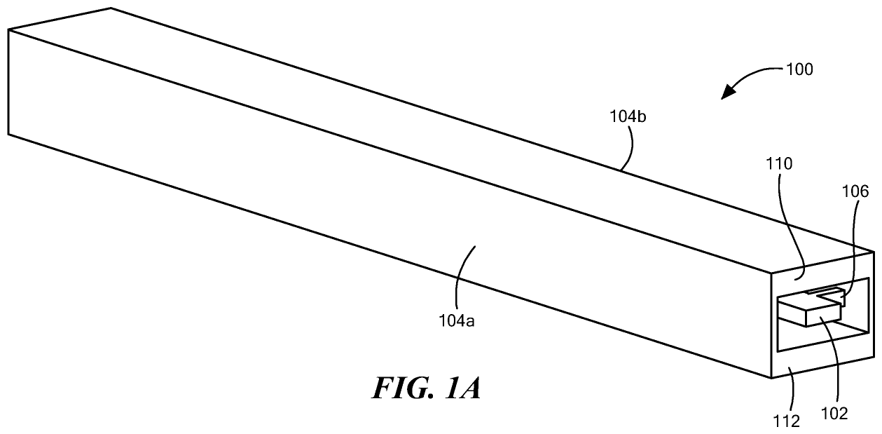

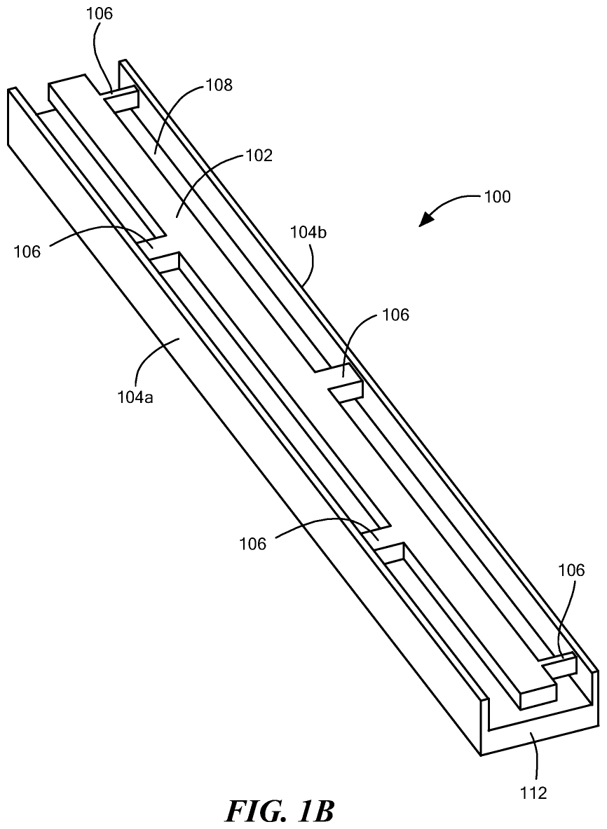

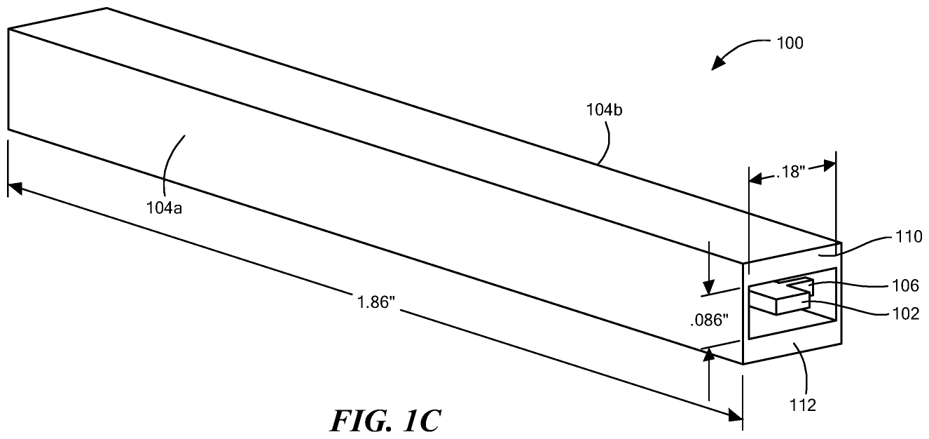

FIGS. 1A and 1B show an example stripline structure 100 having a center conductor 102 mechanically attached to lateral substrates 104a,b by a series of stubs 106. The stubs 106 mechanically support the center conductor 102 within a cavity 108. In embodiments, first and second ground planes 110, 112 are opposed to each other and define sides of the cavity 108.

As used herein, a self-supporting stripline refers to a stripline structure in which a center conductor is fixed in position within a cavity by mechanical support to a substrate without reliance on a dielectric material in the cavity.

In embodiments, since the stubs fix the center conductor in position, air can be the dielectric in the cavity. In other embodiments, a fluid, such as a dielectric liquid, can fill all or part of the cavity with or without transition to a solid state.

In embodiments, at least some of the stubs 106 are electrically connected, i.e., short-circuited, to the substrates 104,b to provide frequency response tuning, as well as mechanical support for the center conductor. In some embodiments, stubs may be open-circuit, i.e., not electrically connected to the lateral substrates 104, but structurally connected to the lateral substrates, such as by a dielectric adhesive.

It is understood that any practical number of stubs in any suitable configuration of mechanical and/or electrical connection to the lateral substrates in any combination can be used to meet the needs of a particular application. For example, some stubs may provide only mechanical connection, some stubs may provide only electrical connection (open or short circuit but no mechanical connection), and some stubs may provide both mechanical and electrical connection. In addition, each stub may have unique parameters with respect to other stubs to meet the needs of a particular application. In example embodiments, no stub symmetry of any kind is required for the individual stubs or number or for configuration of stubs on either side of the center conductor. Also, while the center conductor is shown as flat and elongate, it is understood that the center conductor can have any geometry configured to meet the needs of a particular application.

FIG. 1C shows example dimensions for the self-supported stripline configuration of FIG. 1A. While dimensions may be shown in one or more of the figures, it is understood that dimensions are example values to facilitate an understanding of the illustrative embodiments and should not be construed as limiting in any way.

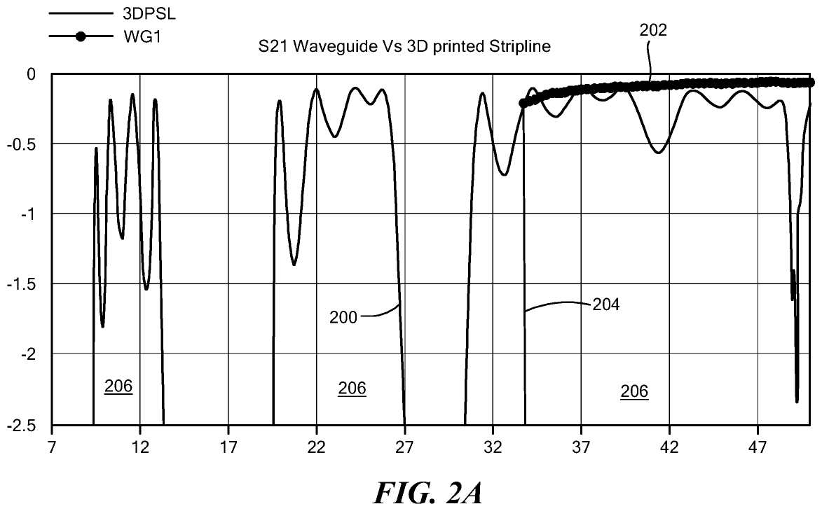

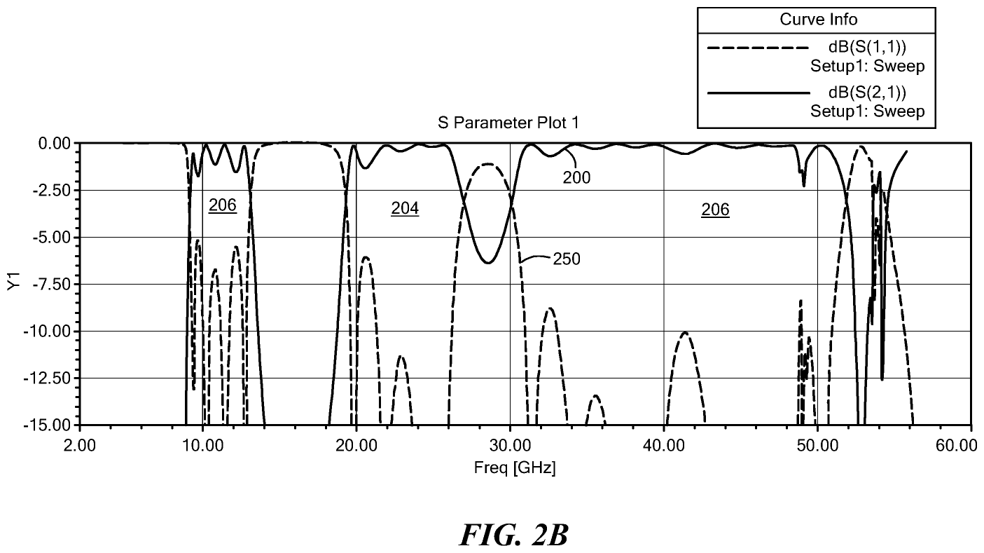

FIG. 2A is a graphical representation of mode S(1,2) frequency response versus dB for an example embodiment of a self-supported stripline embodiment 200 and a comparable conventional waveguide 202 having a cutoff frequency 204. As can be seen, in the illustrated embodiment, the self-supported stripline embodiment 200 has a number of frequency bands 206 to provide multi-band performance.

FIG. 2B is a graphical representation of mode S(1,2) 200 and mode S(1,1) 250 frequency response versus dB for an example embodiment of a self-supported stripline embodiment 200. The mode S(1,2) frequency response 200 of FIG. 2A is shown in further detail along with the mode S(1,1) response.

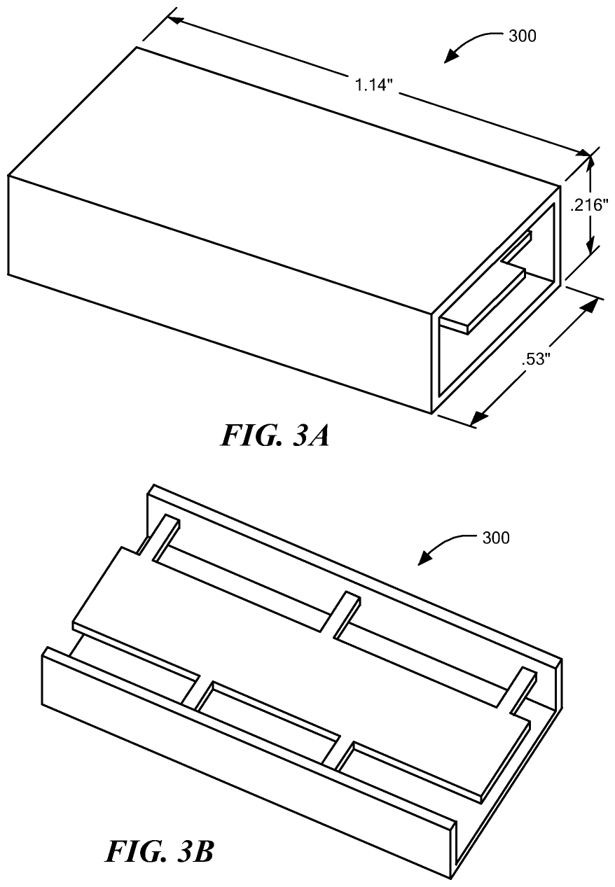

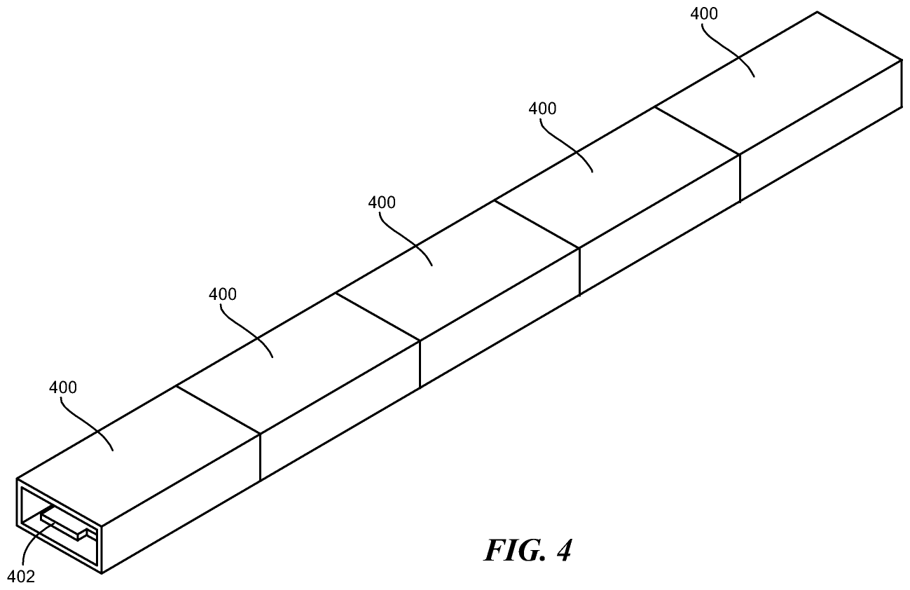

FIGS. 3A and 3B show a further self-supported stripline embodiment 300 having example dimensions. It is understood that the self-supported stripline embodiment 300 will have a different frequency response than the embodiment 100 of FIGS. 1A-1C. As can be seen, the width 0.53 inch is greater than the width 0.18 inch of the embodiment 100 of FIGS. 1A-1C. The width of the center conductor is greater as well. The self-supported stripline embodiment 300 may be suitable for X-band applications and may provide blocks that can be assembled for a complete stripline. FIG. 4 shows a series of self-supported stripline blocks 400 having a self-supported center conductor 402 connected together to achieve a desired length. FIG. 5 shows an example embodiment of a 3D printed self-supported stripline embodiment 500.

It is understood that the blocks are designed to perform well at any practical quantity. That is, the building block is designed once to perform well and any number of them can strung together to achieve similar performance with or without further optimization or design.

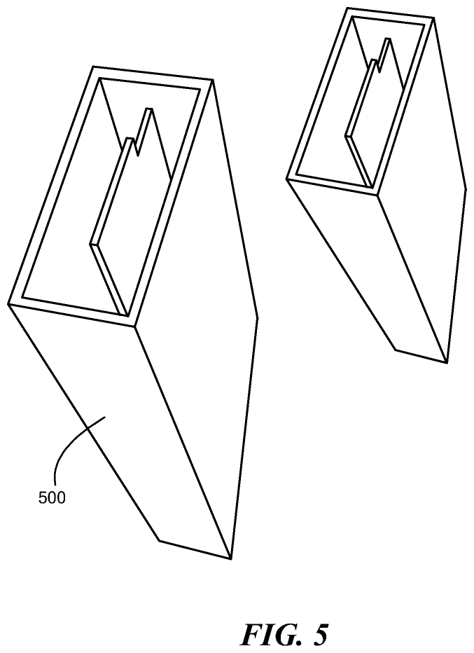

FIG. 6 shows an example self-supported stripline embodiment 600 that connects a first circuit board 602 to a second circuit board 604. In the illustrated embodiment, a portion of the top circuit board 604 is removed to better show the connections. The top and/or bottom circuit boards 602, 604 may be supported by a suitable structure 606, such as 3D printed aluminum housing to facilitate connection to the self-supported stripline embodiment 600. In embodiments, the self-supported stripline embodiment is printed integral to the 3D printed housing 606.

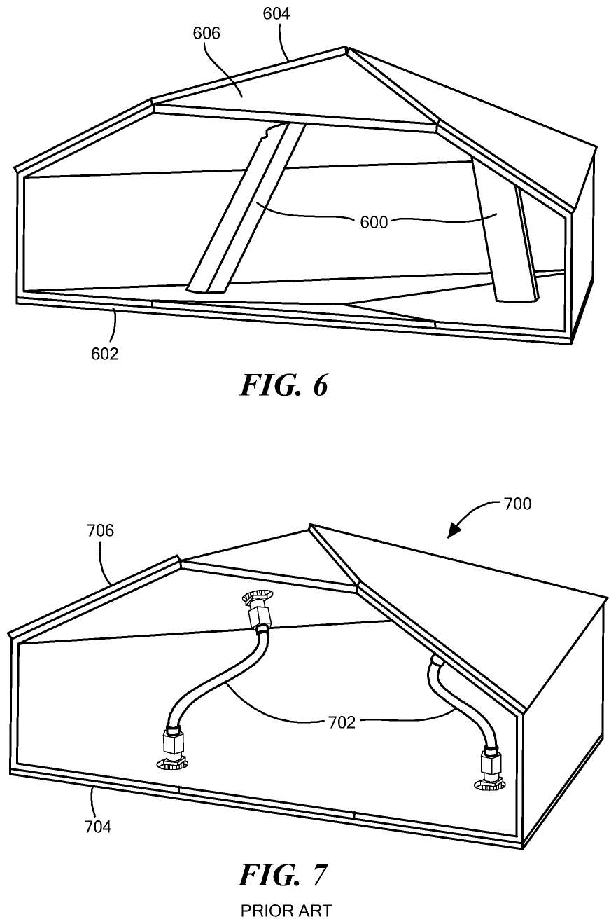

FIG. 7 shows a prior art assembly 700 having coaxial cable connections 702 between first and second circuit boards 704, 706. As is well known, each end of the coaxial cable 702 requires discrete connectors.

In embodiments, self-supported stripline embodiments 600 can replace existing cable assemblies 702 in highly integrated RF subassemblies, for example.

In embodiments, a number of parameters can be selected and optimized for desired performance characteristics. Example input parameters for a self-supported stripline structure include number of stubs, stub location, length of stubs, width of stubs, thickness of stubs, and the like. Example performance characteristics include frequency response, such as frequency bands and widths.

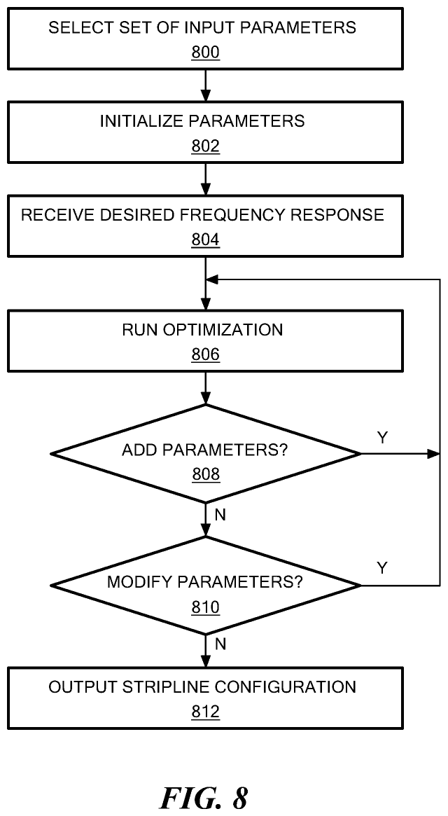

FIG. 8 shows an example set of steps for generating a self-supported stripline structure using optimization for a set of input parameters to achieve a desired frequency response. In step 800, a set of input parameters for a self-supported stripline structure is selected. Example parameters include a number of stubs, stub locations, stub lengths, stub widths, stub thicknesses, number of stubs, and the like. It is understood that any practical number of stub parameters can be selected to meet the needs of a particular application.

In step 802, the selected parameters may be initialized with given values. In step 804, a desired frequency response for a self-supported stripline structure may be received. In step 806, an optimization process is performed to sequentially modify the set of parameters for comparison with the desired frequency response. Suitable commercially available programs are well known in the art. One example optimization program is provided by Keysight Advanced Design System, Optimization Tool.

In optional step 808, further parameters may be added prior to additional optimization in step 806. For example, a first set of parameters may be used to achieve a coarse configuration for a self-supported stripline structure and a second set of parameters may be used to fine tune the configuration of the self-supported stripline structure. In optional step 810, one or more of the parameters may be modified in some way, such as weighted more or less heavily, prior to additional optimization in step 806. In step 812, the output configuration for the self-supported stripline structure can be output for fabrication.

It is understood that any suitable material for example self-supporting stripline structures can used including metals, such as aluminum, and copper. It is further understood that any suitable dielectric material can be used, such as air, dielectric fluid, and the like. Because the stripline is self supporting, the dielectric does not need to serve as structural support. This allows the use of non-structural dielectrics, such as gases (e.g., Air, Argon, Nitrogen etc.), liquids (liquid nitrogen, water, silicone, oil, etc.), powders (e.g., Powdered Teflon, Powdered Ultem, etc.), foams (open or closed cell, etc.) In addition, solid dielectrics can be cast into the self supporting stripline as well, such as epoxy resin for example, or machined and press fitted into place.

In embodiments, mechanical connections from stubs to lateral substrates provides a thermal dissipation path.

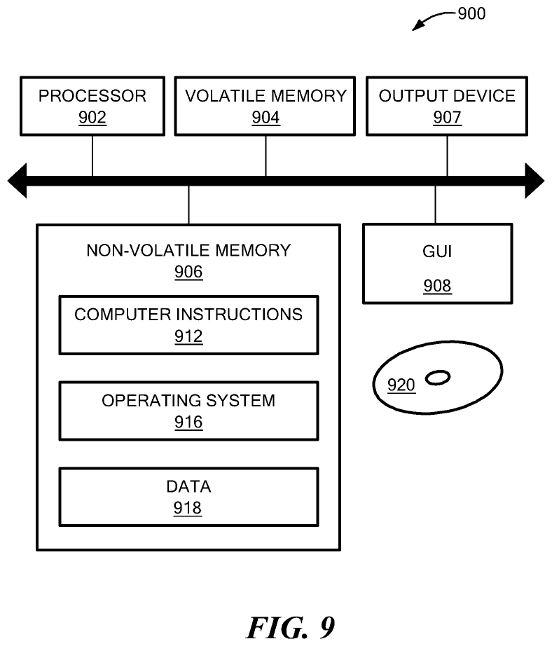

FIG. 9 shows an exemplary computer 900 that can perform at least part of the processing described herein. For example, the computer 900 can perform at least a portion of the processing to perform optimization on a set of input parameters for a self-supporting stripline configuration to achieve a selected frequency response, such as the steps in FIG. 6. The computer 900 includes a processor 902, a volatile memory 904, a non-volatile memory 906 (e.g., hard disk), an output device 907 and a graphical user interface (GUI) 908 (e.g., a mouse, a keyboard, a display, for example). The non-volatile memory 906 stores computer instructions 912, an operating system 916 and data 918. In one example, the computer instructions 912 are executed by the processor 902 out of volatile memory 904. In one embodiment, an article 920 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., RAM/ROM, CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array), a general purpose graphical processing units (GPGPU), and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

1. A system, comprising:
a stripline structure comprising:
a center conductor having stubs;
opposing first and second ground planes that form a cavity, wherein the center conductor is located in the cavity; and
opposing first and second lateral structures, wherein the first lateral structure extends from the first and second ground planes to enclose a first side of the cavity and the second lateral structure extends from the first and second ground planes to enclose a second side of the cavity,
wherein a first one of the stubs is connected to the first lateral structure to fix the center conductor in position within the cavity.

2. The system according to claim 1, wherein the first one of the stubs is electrically connected to the first lateral structure.

3. The system according to claim 2, wherein a second one of the stubs is connected to the second lateral structure to fix the center conductor in position within the cavity.

4. The system according to claim 3, wherein the second one of the stubs is electrically connected to the second lateral structure.

5. The system according to claim 1, wherein the first and second ground planes and the first and second lateral structures comprise the same material.

6. The system according to claim 5, wherein the material is aluminum.

7. The system according to claim 1, wherein the stripline structure is cast.

8. The system according to claim 1, wherein the stripline structure is printed.

9. The system according to claim 1, wherein a dielectric material in the cavity is air.

10. The system according to claim 1, wherein a number of the stubs, location of the stubs, and geometry of the stubs determine a frequency response of the stripline structure.

11. The system according to claim 1, wherein the connection of the first one of the stubs and the first lateral structure provides a thermal dissipation path.

12. The system according to claim 1, wherein the system further includes first and second electrical devices connected by the stripline structure.

13. The system according to claim 12, wherein the system includes antenna elements.

14. A method, comprising:
connecting a first electrical device to a second electrical device using a stripline structure, wherein the stripline structure comprises:
a center conductor having stubs;
opposing first and second ground planes that form a cavity, wherein the center conductor is located in the cavity;
opposing first and second lateral structures, wherein the first lateral structure extends from the first and second ground planes to enclose a first side of the cavity and the second lateral structure extends from the first and second ground planes to enclose a second side of the cavity,
wherein a first one of the stubs is connected to the first lateral structure to fix the center conductor in position within the cavity.

15. The method according to claim 14, further including replacing a coaxial cable or a waveguide with the stripline structure.

16. The method according to claim 14, wherein the first and second electrical devices comprise circuit boards.

17. A method, comprising:
providing a stripline structure comprising:
a center conductor having stubs;
opposing first and second ground planes that form a cavity, wherein the center conductor is located in the cavity; and
opposing first and second lateral structures, wherein the first lateral structure extends from the first and second ground planes to enclose a first side of the cavity and the second lateral structure extends from the first and second ground planes to enclose a second side of the cavity, wherein a first one of the stubs is connected to the first lateral structure to fix the center conductor in position within the cavity, by
selecting a number of the stubs for a given frequency response of the stripline structure.

18. The method according to claim 17, further including selecting a location of the stubs for the given frequency response of the stripline structure.

19. The method according to claim 18, further including selecting a length of the stubs for the given frequency response of the stripline structure.

20. The method according to claim 19, further including selecting a width of the stubs for the given frequency response of the stripline structure.
